(19) United States
(12) Patent Application Publication
(10) Pub. No.: US 2013/0257755 A1
(43) Pub. Date: Oct. 3, 2013

(54) DISPLAY DEVICE FOR A STRUCTURE

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/477,103

(22) Filed: May 22, 2012

Related U.S. Application Data
(63) Continuation-in-part of application No. 13/437,996, filed on Apr. 3, 2012.

(51) Int. Cl. G06F 3/041; G09G 3/36; G09G 3/30

(52) U.S. Cl. 345/173

(57) ABSTRACT

A display device for a structure is provided. The display device includes a display unit, an input unit, and a control unit. The display unit for displaying scenes is disposed in an opening or a surface of the structure, for example, a window, a door, or a wall. The control unit determines a circumstance according to input parameters received by the input unit, and changes the scenes to correspond to the circumstance. The control unit can change the scenes by modifying a color value of pixel data corresponding to pixels of each of the scenes according to values of the input parameters, or by selecting another scene according to the values of the input parameters.

### CROSS-REFERENCE OF RELATED APPLICATIONS

This application is a continuation-in-part of U.S. application Ser. No. 13/437996 filed Apr. 3, 2012 by Cai et al., the entire disclosure of which is incorporated herein by reference.

### BACKGROUND

1. Technical Field

The present disclosure relates to a display device, and particularly to a display device for a structure.

2. Description of Related Art

Many electronic wallpaper devices display scenes of images according to multimedia data received from a device connected to electronic wallpaper, for example, a computer. However, the multimedia data is usually provided according to a pre-stored multimedia file in the device which is manually chosen by a user, and cannot be changed until the user chooses another file.

In addition, a conventional window is usually glazed in some transparent or translucent materials such as glass or paper. For the purpose of increasing artistry or changing transparency, colored glass or patterned paper can be used. However, the above-mentioned materials are hard to be modified to change the color and the pattern.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1A is a schematic diagram of a first embodiment of a display device of the present disclosure in use.

FIG. 1B is a block diagram of the display device shown in FIG. 1A.

FIG. 1C is a schematic diagram of an embodiment of the display unit shown in FIG. 1A.

FIG. 2 is a block diagram of a second embodiment of a display device of the present disclosure.

FIG. 3 is a block diagram of a third embodiment of a display device of the present disclosure.

FIG. 4A is a schematic diagram of a fourth embodiment of a display device of the present disclosure in use.

FIG. 4B is a block diagram of the display device shown in FIG. 4A.

### DETAILED DESCRIPTION

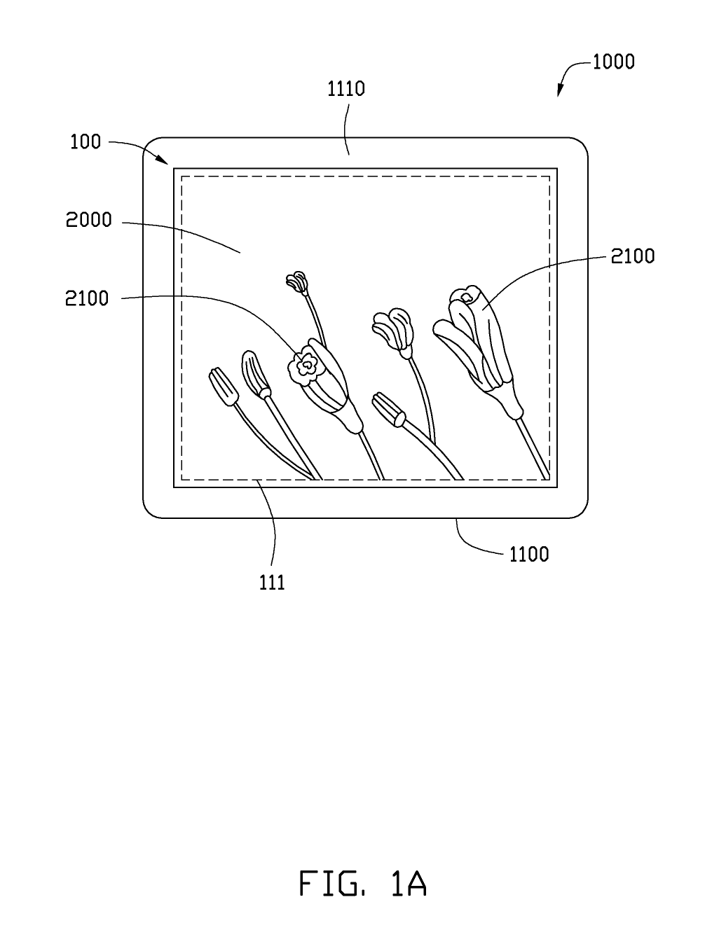

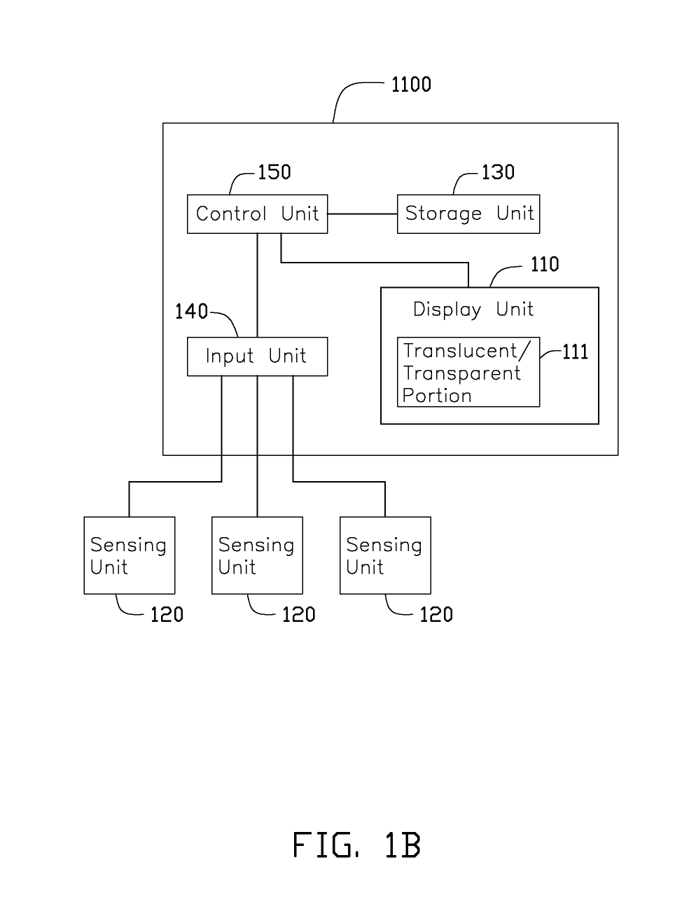

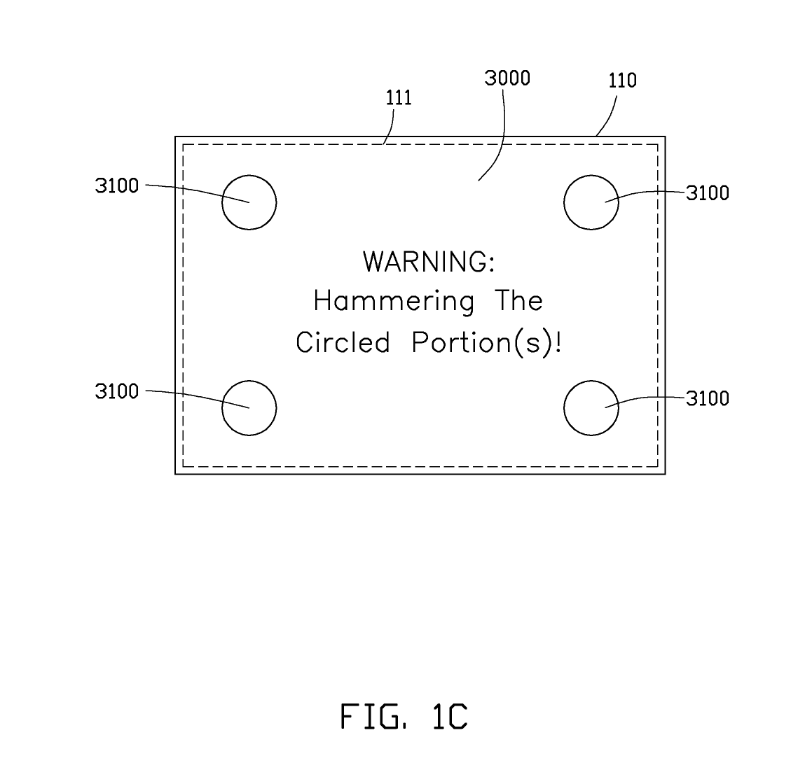

FIG. 1A is a schematic diagram of a first embodiment of a display device 100 of the present disclosure in use. The display device 100 is for an opening of a structure 1000 such as a building or a vehicle in use. FIG. 1B is a block diagram of the display device 100 shown in FIG. 1A. The display device 100 includes a display unit 110, sensing units 120, a storage unit 130, an input unit 140, and a control unit 150. In the illustrated embodiment, the display unit 110 is fixed on a frame 1110 of a window 1100 of the structure 1000. In other embodiments, the display unit 110 can be fixed on a door of the structure 1000. The display unit 110 includes a translucent/transparent portion 111, wherein the translucent/transparent portion 111 has a translucent or transparent structure, which allows the passing of light. The translucent/transparent portion 111 displays a scene 2000. The scene 2000 contains image(s) and/or video(s), which can be, for example, a painting, a cartoon image, a still photograph, or an animation.

In the illustrated embodiment, the display unit 110 is a transparent active-matrix organic light-emitting diode (AMOLED) display. The sensing units 120 are disposed in the exterior of the structure 1000, which are sensors sensing environmental parameters of the outdoor environment such as air temperature, humidity, luminosity, visibility, atmospheric pressure, cloudiness, evaporation, wind velocity, flow velocity, and/or shaking intensity, for example. The storage unit 130, the input unit 140, and the control unit 150 are disposed in the frame 1110 of the window 1100. In other embodiments, the display unit 110 can be another type of electronic display having a translucent or transparent structure which can display scene(s). A portion or all of the sensing units 120 can be disposed in the interior of the structure 1000, and can be other types of devices sensing indoor/outdoor environmental parameter(s) or other information, for example, a device sensing parameters of the changes in the status such as the movement or the deformation of an object. The storage unit 130, the input unit 140, and the control unit 150 can be an individual device such as a computer, which connects to the display unit 110 and the sensing units 120.

The storage unit 130 is a device such as a high speed random access memory, a non-volatile memory, or a hard disk drive for storing and retrieving digital information, which stores image data of the scene 2000 to be displayed by the translucent/transparent portion 111 of the display unit 110. Wherein the image data includes a plurality of pixel data corresponding to pixels of the scene 2000. The translucent/transparent portion 111 displays the scene 2000 according to the image data. In the illustrated embodiment, the input unit 140 receives the environmental parameters produced by the sensing units 120. In other embodiments, the input unit 140 can receive other types of information from other types of devices. For instance, the input unit 140 can receive multimedia data such as text, still image, video, or audio from a multimedia device.

The control unit 150 changes the scene 2000 by determining a circumstance according to the environmental parameters and changing the scene 2000 to correspond to or be complementary with the circumstance, while the scene 2000 can be changed according to the environmental parameters. For instance, when the environmental parameters include wind velocity and the change of the wind velocity has determined by the control unit 150, the control unit 150 changes the scene 2000 according to the wind velocity in the environmental parameters to represent the movement of object FIGS. 2100 in the scene 2000, thereby simulating the movement of objects represented by the object FIGS. 210 in a wind of the changed wind velocity. In addition, when the control unit 150 simulates the movement of an object in the wind, the characters of the object such as the size, the weight, the shape, and the material can be considered. Furthermore, when the environmental parameters include air temperature and humidity, the control unit 150 determines the change of the air temperature and the humidity in the environmental parameters which represent the change of the weather, and changes the scene 2000 to represent the change of the weather in the scene 2000 by, for example, changing the color tone of the scene 2000, to correspond to or be complementary with the weather.

In the illustrated embodiment, the control unit 150 changes the scene 2000 by modifying a color value of one or more of the pixel data according to value(s) of the environmental parameters, thereby representing the movement of the object FIGS. 2100. In addition, the control unit 150 can modify the color value of the pixel data to correspond to or be complementary with the value(s) of the environmental parameters. For instance, when the value(s) of one of the environmental parameters represents it is cold, the control unit 150 can modify the color value of the pixel data to be complementary with the value(s) of the environmental parameters, such that the scene 2000 has a warmer color. In other embodiments, the storage unit 130 can store a plurality of image data of scenes to be displayed. Correspondingly, the control unit 150 can change the scene 2000 by selecting another of the image data according to the value(s) of the environmental parameters.

FIG. 1C is a schematic diagram of an embodiment of the display unit 110 shown in FIG. 1A. In the illustrated embodiment, the body of the display unit 110 is composed of tempered glass, which can more easily be broken in some portions than other portions according to, for example, mechanical theory. The storage unit 130 stores breakable portion information corresponding to the breakable portion of the display unit 110. The input unit 140 receives an emergency information produced by, for example, a hazard alarm system. The control unit 150 determines a circumstance according to the emergency information. If the circumstance represents an emergency which evacuation is recommended, the control unit 150 changes a scene 3000 displayed by the translucent/transparent portion 111 according to the breakable portion information. For instance, when the breakable portions are at four corners of the display unit 110, the scene 3000 including breakable portion FIGS. 3100 at four corners of the scene 3000 are displayed. The breakable portion FIGS. 3100 are displayed corresponding to the breakable portions of the display unit 110, thereby informing people of the information about breaking the display unit 110. In other embodiments, the display unit 110 may include a tempered glass having breakable portions. Correspondingly, the storage unit 130 stores breakable portion information corresponding to the breakable portion of the tempered glass.

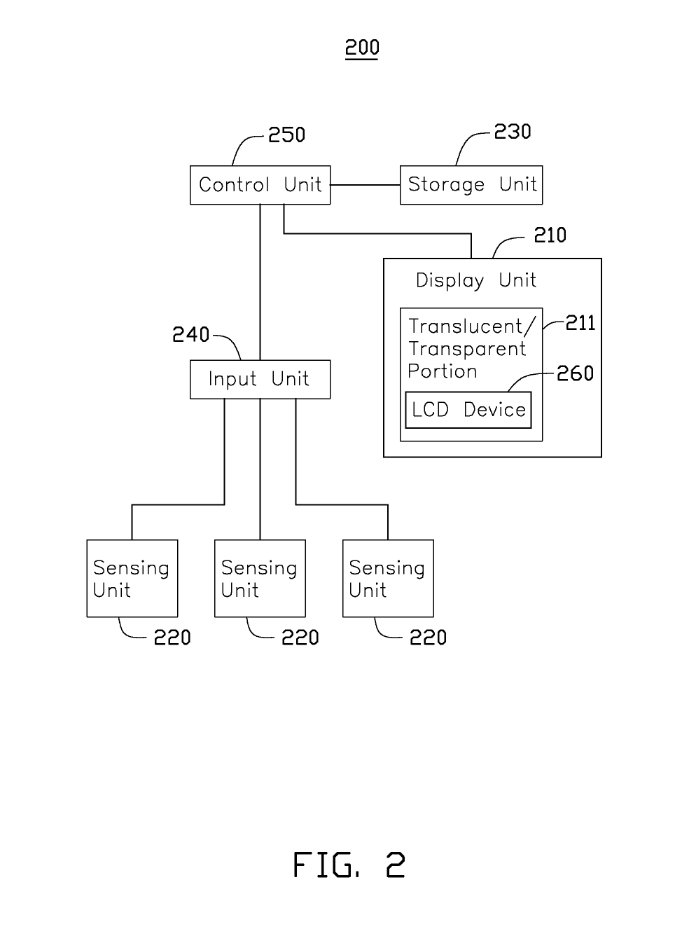

FIG. 2 is a block diagram of a second embodiment of a display device 200 of the present disclosure. The display unit 200 includes a display unit 210, sensing units 220, a storage unit 230, an input unit 240, a control unit 250, and a liquid crystal display (LCD) device 260. One of the sensing units 220 is disposed in the interior of a structure to detect the brightness in the structure. The LCD device 260 is a LCD panel which covers a side of a translucent/transparent portion 211 of the display unit 210. The LCD device 260 includes liquid crystal particles capable of preventing lights from passing through the LCD device 260. The control unit 250 controls the movement of the liquid crystal particles according to environmental parameters received by the input unit 240 from the sensing units 220 to adjust a transparency of the LCD device 260, thereby controlling the amount of light passing through the LCD device 260. Consequently, a brightness of the scenes displayed by the display unit 210 can be changed, and the amount of the light entering the structure through a window where the display unit 210 is located can be changed. In the illustrated embodiment, the control unit 250 adjusts the transparency of the LCD device 260 to be complementary with value(s) of the environmental parameters. For instance, when the value(s) of one of the environmental parameters represents insufficiency or excess of the brightness in the structure 1000, the control unit 250 adjusts the transparency of the LCD device 260 to be complementary with the value(s).

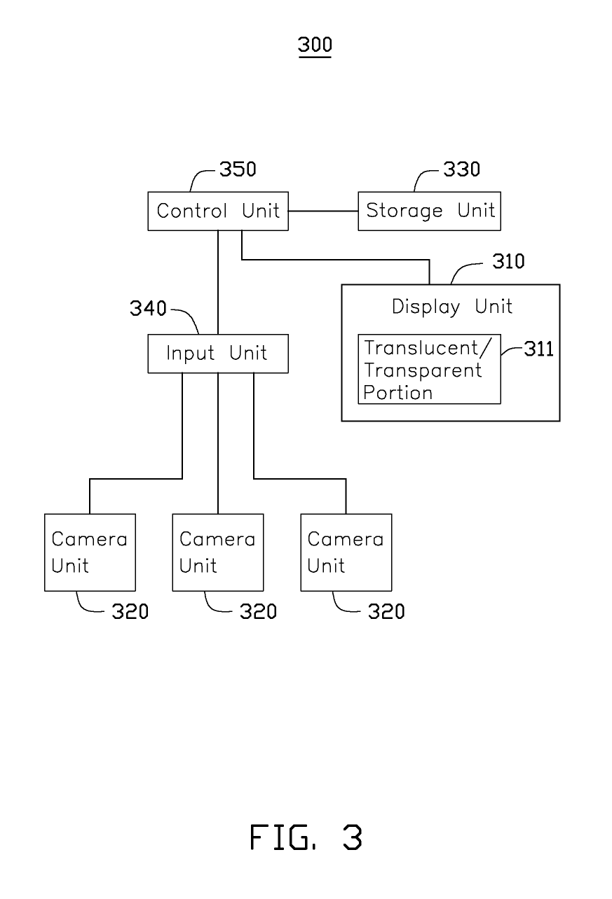

FIG. 3 is a block diagram of a third embodiment of a display device 300 of the present disclosure. The display unit 300 includes a display unit 310, a camera unit 320, a storage unit 330, an input unit 340, and a control unit 350. The camera unit 320 may include a camera capable of capturing images such as still photographs or videos. The camera unit 320 captures scene images of the scene which can be viewed through a translucent/transparent portion 311 of the display unit 310, and produces scene information according to the scene images. The control unit 350 changes a scene displayed by the translucent/transparent portion 311 by determining a circumstance according to the scene information and changing the scene to correspond to or be complementary with the circumstance, while the scene can be changed according to the scene information. For instance, when the circumstance represents an event such as sunrise, the control unit 350 changes the scene displayed by the translucent/transparent portion 311 to include a subtitle with a date, thereby informing people about the start of a day on that date.

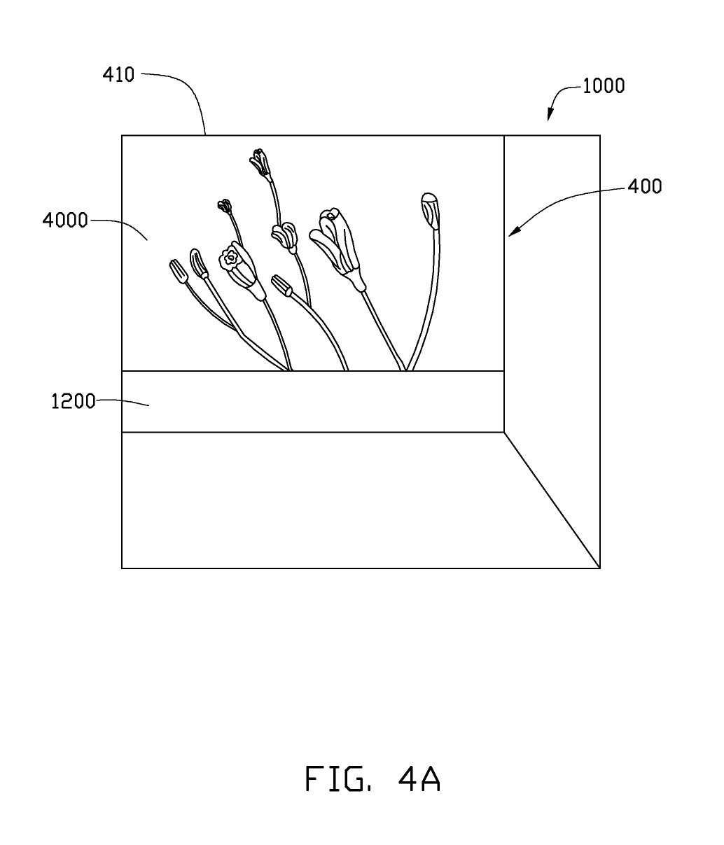

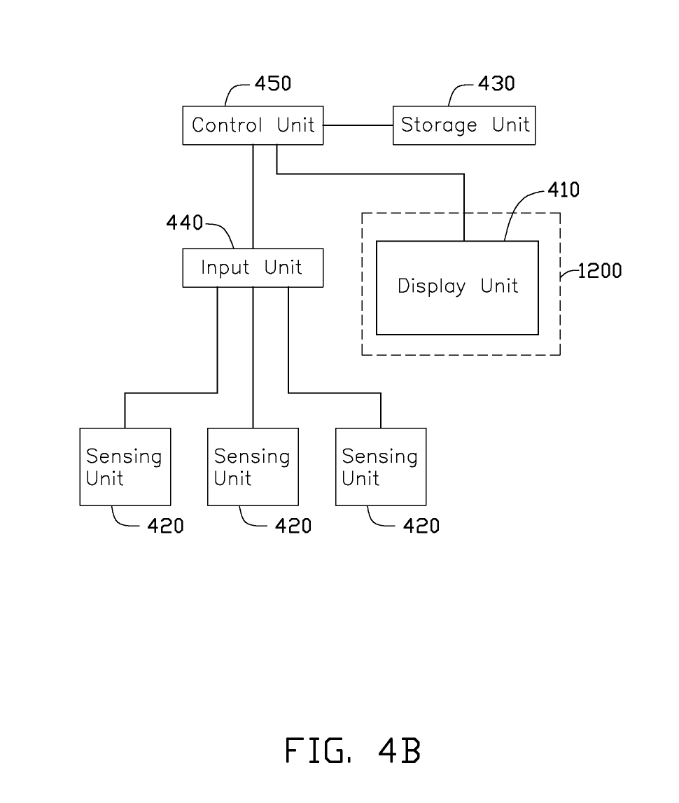

FIG. 4A is a schematic diagram of a fourth embodiment of a display device of the present disclosure in use. The display device 400 is for a surface of the structure 1000. FIG. 4B is a block diagram of the display device 400 shown in FIG. 4A. The display device 400 includes a display unit 410, sensing units 420, a storage unit 430, an input unit 440, a control unit 450, and a camera unit 460. The display unit 410 is fixed on a wall 1200 of the structure 1000. The display unit 410 displays a scene 4000. In the illustrated embodiment, the display unit 410 is an electronic paper. In other embodiments, the display device 410 can be another type of electronic display such as organic light-emitting diode (OLED) display. The sensing units 420 are disposed in the exterior of the structure 1000, which are sensors sensing environmental parameters of the outdoor environment. The storage unit 430 stores image data of the scene 4000 to be displayed by the display unit 410, wherein the image data includes a plurality of pixel data corresponding to pixels of the scene 4000. The display unit 410 displays the scene 4000 according to the image data. In the illustrated embodiment, the input unit 440 receives input parameters including the environmental parameters received from the sensing units 420 and scene information received from the camera unit 460. In other embodiments, the input unit 440 can receive other types of information from other types of devices. For instance, the input unit 140 can receive multimedia data from a multimedia device

The control unit 450 changes the scene 4000 by determining a circumstance according to the input parameters and changing the scene 4000 to correspond to or be complementary with the circumstance, while the scene 4000 can be changed according to the input parameters. In the illustrated embodiment, the control unit 450 changes the scene 4000 by modifying a color value of one or more of the pixel data according to value(s) of the input parameters. In other embodiments, the storage unit 430 can store a plurality of image data of scenes to be displayed. Correspondingly, the control unit 450 can change the scene 4000 by selecting another of the image data according to the value(s) of the input parameters. In the illustrated embodiment, the storage unit 430, the input unit 440, and the control unit 450 is an individual device such as a computer, which connects to the display unit 410. The camera unit 460 may include a camera capable of capturing images such as still photographs or videos, which captures scene images and produces scene information according to the scene images. The control unit 450 may change the scene 4000 by determining a circumstance according to the scene information and changing the scene 4000 to correspond to or be complementary with the circumstance, while the scene 4000 can be changed according to the scene information.

The display device is capable of changing the color and the pattern by simply inputting information such as multimedia data or environmental parameters to the input unit of the display device, which increases the decorative effect of a display device for a structure.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display device for a structure, comprising:
a display unit disposed in the structure, wherein the display unit displays one or more scenes;
an input unit receiving one or more input parameters; and
a control unit determining a circumstance according to the one or more input parameters and changing the one or more scenes to correspond to the circumstance.

2. The display device of claim 1, wherein the circumstance comprises the change of the one or more input parameters, the control unit changes the one or more scenes to correspond to the change of the one or more input parameters.

3. The display device of claim 2, further comprising one or more sensing units sensing the one or more input parameters comprising one or more environmental parameters.

4. The display device of claim 3, wherein the one or more environmental parameters comprise wind velocity, the control unit determines the change of the wind velocity in the one or more environmental parameters according to the wind velocity in the one or more environmental parameters, and changes the one or more scenes to represent the movement of one or more object figures in the scene according to the wind velocity.

5. The display device of claim 1, wherein the control unit changes the one or more scenes according to at least a value of the one or more input parameters.

6. The display device of claim 1, wherein the display unit is disposed in an opening of the structure, the display unit comprises a translucent/transparent portion displaying the one or more scenes.

7. The display device of claim 6, wherein the display unit is fixed on at least one of a window of the structure and a door of the structure.

8. The display device of claim 6, wherein the display unit is a transparent AMOLED (active-matrix organic light-emitting diode) display.

9. The display device of claim 6, wherein the display unit comprises a LCD (liquid crystal display) device comprising liquid crystal particles, the LCD device is disposed corresponding to the translucent/transparent portion of the display unit, the control unit controls the movement of the liquid crystal particles according to the one or more input parameters to adjust a transparency of the LCD device.

10. The display device of claim 6, further comprising a storage unit, wherein the display unit comprises one or more breakable portions, the storage unit stores breakable portion information corresponding to the one or more breakable portions, when the circumstance corresponds to an emergency, the control unit changes the one or more scenes according to the breakable portion information to comprise one or more breakable portion figures representing the one or more breakable portions.

11. The display device of claim 6, further comprising a camera unit capturing one or more scene images with respect to the translucent/transparent portion of the display unit and producing the one or more input parameters comprising scene information according to the one or more scene images, the control unit determines the circumstance according to the scene information in the one or more input parameters.

12. The display device of claim 1, wherein the display unit is fixed on a wall of the structure.

13. The display device of claim 1, further comprising a storage unit storing one or more image data corresponding to each of the one or more scenes, wherein the display unit displays the one or more scenes according to the one or more image data, each of the one or more image data comprises a plurality of pixel data corresponding to pixels of each of the one or more scenes, the control unit changes the one or more scenes by modifying a color value of one or more of the pixel data according to at least a value of the one or more input parameters.

14. The display device of claim 13, further comprising one or more sensing units sensing the one or more input parameters comprising one or more environmental parameters, the control unit modifies the color value of one or more of the pixel data according to at least a value of the one or more environmental parameters in the one or more input parameters.

15. The display device of claim 1, further comprising a storage unit storing one or more image data of the one or more scenes to be displayed, the control unit changes the one or more scenes by selecting another of the one or more image data according to at least a value of the one or more input parameters.

16. The display device of claim 1, further comprising a camera unit capturing one or more scene images and producing the one or more input parameters comprising scene information according to the one or more scene images, the control unit determines the circumstance according to the scene information in the one or more input parameters.
